(19) United States
(12) Patent Application Publication
(10) Pub. No.: US 2006/0023024 A1
(43) Pub. Date: Feb. 2, 2006

(54) Inkjet recording apparatus

(75) Inventor: Yukihiro Niekawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/190,124

(22) Filed: Jul. 27, 2005

(30) Foreign Application Priority Data
Aug. 2, 2004 (JP) JP2004-225658

(51) Int. Cl. B41J 23/00

(52) U.S. Cl. 347/37

(57) ABSTRACT

An inkjet recording apparatus includes: a serial recording head having nozzles which jet photocurable ink; a light source which irradiates light onto the ink that landed on a recording medium and cures the ink; a primary scanning mechanism that reciprocates a carriage on which the recording head and the light source are provided, in a primary scanning direction; at least one irradiated body provided at a carriage standby position in at least one end of the scanning range of the carriage, absorbing heat released from the light source; a memory section which has capacity to store image data required for at least one scanning operation, and temporarily stores image data received from an external device; and a controller controls the carriage to wait at the standby position and not to scan until image data for one scanning operation or more is stored in the memory section.

This application is based on Japanese Patent Application No. JP2004-225658 filed on Aug. 2, 2004, the entire of which is hereby incorporated by reference.

### BACKGROUND OF THE INVENTION

This invention relates to an inkjet recording apparatus and more specifically, to an jet recording apparatus that uses photocurable ink to record images.

In recent years, use of the inkjet recording apparatus has increased because of its simpler structure and the fact that image recording can be performed at a lower cost when compared to image recording apparatuses that require a printing plate such as the gravure printing type and the flexographic printing type.

In fields in which image recording is performed on products or product packaging using this type of inkjet recording apparatus, materials which have no ink absorbing capability such as resins or metals are often used as the product or the product packaging. A photocure type inkjet recording apparatus is also known in which, in order to fix the ink on the recording medium when the type of material which has no ink absorbing capability is used as the recording medium, a photocurable ink is used and after the ink is jetted onto the recording medium, light such as ultraviolet light for example, is irradiated thereon and the ink is thereby photocured and fixed.

In this type of inkjet recording apparatus, after ink is jetted onto the recording medium, it is necessary for light to be irradiated onto the recording medium before ink blotting or color changes occurs so that the ink can be cured and fixed on the ink recording medium. However, on the other hand, the ink that is in the recording head or in the ink supply tube and the like before being jetted from the nozzle of the recording head, or ink to be discharged in the maintenance unit or at the home position, must be kept in a liquid state without being cured.

As a result, the inkjet printer of Patent Document 1 controls the irradiation means such that ultraviolet light is not irradiated onto the recording medium in a range other than that in which the ink has been jetted. That is to say, the inkjet printer described in Patent Document 1 is a serial inkjet recording apparatus that is provided with a platen which supports the recording medium and a pair of guide rails which extend in the primary scanning direction above the platen, and jets ink from the nozzles of a recording head while the carriage on which the recording head is loaded, is scanned in the conveyance direction of the recording medium (secondary scanning direction) and the direction perpendicular thereto (the primary scanning direction) based on the print data input from a host system. In addition, the irradiation means is controlled by the control section such that when the carriage enters the recording area, the shutter of the shutter mechanism of the irradiating means is opened and irradiation of ultraviolet light from the light source begins and when the carriage enters a region other than the recording area, the shutter closes and irradiation of ultraviolet light stops.

As a result, ink jetting and discharge at the time of recording can be performed smoothly without curing the ink which is present inside the recording head or the ink supply tube prior to jetting of the ink from the printing section or ink discharged at the maintenance unit or home position. Patent Document 1: Japanese Patent Application Laid-Open No. 2003-127347 publication.

However, in this type of serial inkjet recording apparatus, if after recording begins, data transfer from the host system or data processing is delayed and printing cannot be performed continuously, the carriage stops temporarily at a location other than the standby position such as on the recording medium or on the platen until all the print data is obtained. If ultraviolet light irradiation is continued in this state where the carriage is at a location other than the standby position, the mechanisms inside the printer are heated by the heat from the light source, and this has the adverse effects of impairing drive stability of the recording head and the light source due to the increase in temperature of the carriage itself due to radiant heat and of reducing the lifespan of the apparatus. Furthermore, the ultraviolet light which leaks from the light source is irradiated within the apparatus due to the stopping of the carriage at a position other than the dedicated standby position, and thus deterioration of the mechanism and curing of the ink at portions where curing is unneeded occurred.

In addition, the recording medium and the platen which supports the recording medium deforms as a result of being heated to a high temperature and this causes a problem in that flatness of the recording medium at the time of recording is impaired due the occurrence of creases or curls for example, and this results in reduced image quality.

In particular, in the serial inkjet printer, in order to shorten the time for the irradiation of light and thereby increase the efficiency of ink curing, a light source with a large heat generation capacity such as a high-pressure mercury lamp and the like is often used as the light source for the irradiation device. Thus, the volume of heat supplied to the object to be irradiated (referred to as object for irradiation, or irradiated body hereinafter) is extremely large and there is a strong tendency for the phenomena described above to occur.

Also, it is desirable that the light source is turned off while the carriage is on standby at which time the ink that landed on the recording medium is not being cured. However, because high output light sources such as high-pressure mercury lamps or metal halide lamps or the like require a fixed time from the time it is turned on to the time when the radiation level becomes stable, and because the lifespan of the light source depends on the frequency with which the lamp is usually switched on and off, it is desirable that the lamp remains on provided that the standby state is within a fixed time.

### SUMMARY OF THE INVENTION

The invention was devised in view of the foregoing situation and the object thereof is to provide an inkjet recording apparatus that has a structure that makes it possible to reduce the amount of heat from the light source that heats the recording medium or the platen in the recording area without stopping the carriage at locations other than the standby position even when data transfer from the host system or data processing is delayed after recording has started.

The foregoing object is achieved by any one of the following Structures (1)-(6).

(1): An inkjet recording apparatus includes: a serial recording head that has nozzles which jet photocurable ink onto a recording medium; a light source which irradiates light onto the ink that landed on the recording medium and cures the ink; a primary scanning mechanism that moves a carriage on which the recording head and the light source are provided, back and forth in the primary scanning direction; an object for irradiation which is provided at a carriage standby position which is positioned at both ends of the scanning range of the carriage and absorbs heat released from the light source; a memory section which has sufficient capacity to store image data required for at least one scanning operation, and which temporarily stores image data received from an external device; and a control section which performs control such the carriage is on standby at the standby position and the carriage does not perform scanning until image data for one scanning operation is stored in the memory section.

According to structure (1), in the configuration in which the carriage standby position is at both ends of the scanning range of the carriage, because the control section waits until an amount of image data received from the external device which is the amount for one scanning operation is stored in the memory section before the carriage is allowed to scan in the recording area, when the recording process is completed, the carriage will have arrived at the standby position at one end of the scanning range of the carriage. Thus after recording begins, the carriage never stops at a location other than the standby position on the recording medium or platen due to delay in the transfer of image data. As a result, the situation is avoided in which ultraviolet light continues to be irradiated from the light source onto the recording medium and platen in a state where the carriage is at a location other than the standby position. Furthermore, the carriage is always stopped at the carriage standby position when recording is not being performed and thus the situation is also avoided in which ultraviolet light that leaks from the light source is irradiated inside inkjet recording apparatus.

Furthermore, because heat from the light source is absorbed by the object for irradiation, heating of the carriage to high temperatures is avoided.

(2): An inkjet recording apparatus includes: a serial recording head that has nozzles which jet photocurable ink onto a recording medium; a light source which irradiates light onto the ink that landed on the recording medium and cures the ink; a primary scanning mechanism which moves a carriage on which a recording head and a light source are provided, back and forth in the primary scanning direction; an object for irradiation which is provided at the carriage standby position which is positioned at one end of the scanning range of the carriage and absorbs heat released from the light source; a memory section which has sufficient capacity to store image data required for at least two scanning operations, and which temporarily stores image data received from an external device; and a control section which performs control such that the carriage does not perform scanning until image data for two scanning operations are stored in the memory section and the carriage is on standby at the standby position.

According to Structure (2), even in the configuration in which the carriage standby position is only at one end of the scanning range of the carriage, because the control section waits until image data received from the external device for two scanning operations is stored in the memory section before the carriage is allowed to scan in the recording area, image recording can be performed without the carriage stopping at locations other than the standby position.

(3): The inkjet recording apparatus described in Structure (2), wherein the memory section has the capacity to store image data for at least three scanning operations or more.

According to structure (3), even in the configuration in which the carriage standby position is only at one end of the scanning range of the carriage, even if the memory section receives new image data while the carriage is in the recording area, because capacity for a maximum of two scanning operations is secured for the image data being recorded in the memory section and capacity for one scanning operation is secured for the new image data being received, the same effects as those of Structure (2) can be obtained.

(4): The inkjet recording apparatus described in any one of Structures (1) to (3), wherein a cooling means for cooling the object for irradiation is provided.

According to structure (4), by actively cooling the object for irradiation which absorbs heat from the light source, heating of the internal parts of the inkjet apparatus to high temperatures can be effectively prevented.

(5): The inkjet recording apparatus described in any one of Structures (1) to (4), wherein the light source irradiates ultraviolet light.

According to Structure (5), because the light source irradiates ultraviolet light in order to cure the ink, curing properties are higher than when using light sources that irradiate other lights and cost is kept low.

(6): The inkjet recording apparatus described in any one of Structures (1) to (5), wherein the photocurable ink is a cation polymerizable ink.

According to Structure (6), by using the cation polymerizable ink which is an ink with high curing sensitivity that is cured by a light source with comparatively low output, it becomes possible to use a low output light source.

According to Structure (1), even if data transfer of data from the host system and data processing is delayed after recording starts, because the carriage never stops at a location other than the standby position such as on the recording medium or platen, heating of the recording medium and the platen which supports the recording medium to high temperatures due to heat from the light source can be suppressed. As a result, deformation of the recording medium and the platen is prevented, and flatness of the recording medium during recording is ensured and reduction in image quality is avoided.

In addition, because the object for irradiation absorbs heat from the light source at the standby position, the temperature of the carriage itself is prevented from increasing due to the radiant heat from the light source, and thus impairment of the drive stability of the recording head and the light source, as well as reduction in lifespan can be avoided. In addition, because the carriage is stopped at the standby position when recording is not being performed, ultraviolet light which leaks from the light source is prevented from being irradiated inside the recording apparatus and causing deterioration of the mechanisms or causing the ink to cure at portions where this is not needed.

According to Structure (2), even in the configuration in which the carriage standby position is only at one end of the scanning range of the carriage, the carriage never stops at a location other than the standby position such as on the recording medium or platen due to delay in image data transfer, and the same effects as those of Structure (1) can be obtained by ensuring that carriage is on standby at the standby position.

According to Structure (3), even in the configuration in which the carriage standby position is only at one end of the scanning range of the carriage, even if the memory section receives new image data while the carriage is in the recording area, because the memory section has the capacity for storing new image data for one scanning operation, the same effects as those of Structure (2) can be obtained.

According to Structure (4), by actively cooling the object for irradiation, heating of the internal parts of the inkjet recording apparatus to high temperatures can be prevented, and thus loss of drive stability of the recording head and the light source which are loaded on the carriage, as well as reduction in lifespan of the apparatus itself can be avoided.

According to Structure (5), because the light source irradiates ultraviolet light in order to cure the ink, curing properties are higher than when using light sources that irradiate other lights and cost is kept low.

According to Structure (6), by using the cation polymerizable ink which is an ink with high curing sensitivity that is cured by a light source with comparatively low output, it becomes possible to use a low output light source.

### BRIEF DESCRIPTION OF THE DRAWINGS

FIG. 1 is a plan view showing the schematic structure of the inkjet recording apparatus of the first embodiment.

FIG. 2 is a front view showing the main portions of the first embodiment.

FIG. 3 is perspective view showing the structure of the cooling unit and the cooling fan of the first embodiment.

FIG. 4 is back surface view showing the structure of the cooling unit and the cooling fan of the first embodiment.

FIG. 5 is block diagram showing the structure of the inkjet recording apparatus of the first embodiment.

FIG. 6 is a flowchart showing the operation of the inkjet recording apparatus of the first embodiment.

FIG. 7 is a plan view showing the schematic structure of the inkjet recording apparatus of the second embodiment.

FIG. 8 is a flowchart showing the operation of the inkjet recording apparatus of the second embodiment.

### DETAILED DESCRIPTION OF THE PREFERRED EMBODIMENTS

### First Embodiment

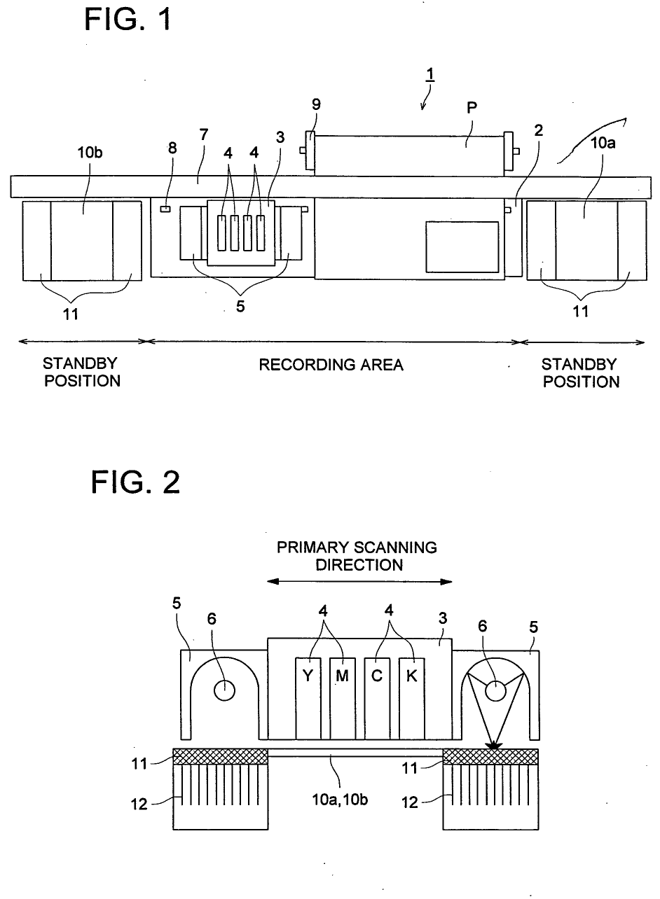

The following is a description of the first embodiment of this invention with reference to FIGS. 1 through 6.

The inkjet recording apparatus 1 of this embodiment is the serial type and the carriage 3 on which the recording head 4 is loaded, is moved back and forth in the primary scanning direction with respect to the recording medium P which is no longer being conveyed in the secondary scanning direction, while ink is jetted onto the recording medium P by the recording head 4 in the advance path and the return path respectively of the carriage 3, and images are thereby recorded. This recording method performs printing in both directions.

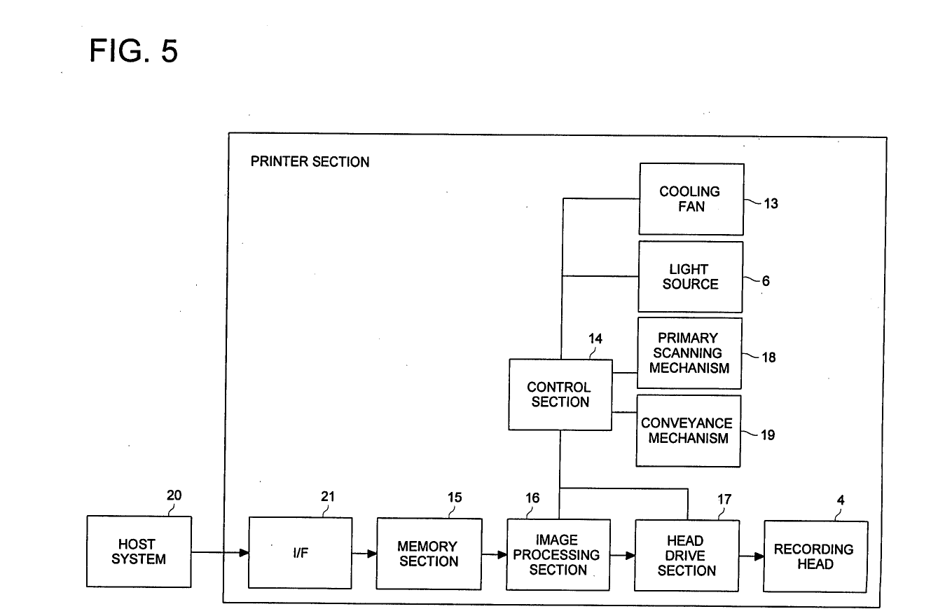

As shown in FIG. 1, the inkjet recording apparatus 1 of this embodiment has a guide rail 7 that extends in the primary scanning direction. The carriage 3 is supported on the guide rail 7 and the carriage 3 is moved in the primary scanning direction above the guide rails by the drive motor in the primary scanning mechanism 18 that is not shown in FIG. 1 (See FIG. 5).

The carriage 3 has a recording head 4 which is disposed such that its longitudinal direction is parallel to the secondary scanning direction and the nozzle surface of the recording head 4 is disposed so as to oppose the recording medium P. Photocurable ink of the colors yellow (Y), magenta (M), cyan (C), and black (B) is jetted from the opening of the nozzle onto the recording medium P.

The photocurable ink used in this embodiment is a cation polymerizable ink selected from among ultraviolet light curable inks, which has very little inhibiting effect on the polymerization reaction due to oxygen and is superior in functionality and versatility. The cation polymerizable ink is a mixture including at least a cation polymerizable compound such as an oxetane compound, an epoxy compound or a vinyl ether compound, photo-cation initiator and coloring material and has the property of being cured when irradiated with ultraviolet light.

An irradiation device 5 for irradiating light on the ink that landed on the recording medium P and curing the ink is loaded at both sides of the carriage 3 in the primary scanning direction. A light source 6 is provided inside the irradiation device 5, and in this embodiment, the ultraviolet light source 6 is used as the light source 6. In this embodiment, remarkable effects can be obtained when a light source with great heat output, such as a high pressure mercury lamp in particular is used. It is to be noted that other examples of the light source 6 include a metal halide lamp, a hot cathode tube, a cold cathode tube, a LED, an electrodeless lamp, an excimer lamp, a low pressure mercury lamp, and at least one of these may be used.

The middle portion of the scanning region of the carriage 3 is a recording area for performing recording on the recording medium P. The recording area has a platen 2 which is positioned below the carriage 3 and supports the recording medium P in a flat state. Conveying roller 8 which is driven by a conveying motor (not shown) is provided at the upstream side of the platen 2. A recording medium winding roller 9 on which a long reel of recording medium P is wound, is provided further upstream of platen 2 in the secondary scanning direction. The recording medium winding roller 9 is rotatable in the axial direction and one end thereof is movable in accordance with the width of the recording medium P. In this embodiment, the conveying mechanism 19 is constituted by the platen 2, the recording medium winding roller 9, the conveying motor and conveying roller 8 (see FIG. 5), and the recording medium P is intermittently conveyed in the secondary scanning direction of the recording medium P.

Flat cooling units 10a and 10b which are provided to have substantially the same flat surface as platen 2 are disposed at both ends of the scanning area of the carriage 3, and the standby position for the carriage 3 is above these cooling units 10a and 10b. The cooling units 10a and 10b have an object for irradiation 11 at a position which faces the irradiation device 5 disposed at both sides of the carriage 3 when the carriage 3 is on standby at the standby position.

The object for irradiation 11 is coated with a material that absorbs light at the surface for irradiation which receives light. This material is preferably an organic or inorganic material with a high absorption rate for ultraviolet light, and more specifically, examples of the inorganic substances include carbon black, titanium oxide formed into extra-fine particles, zinc oxide, and iron oxide (α-Fe₂O₃, Fe₃O₄), and examples of the organic substances include benzotriazole compounds and aromatic compounds. Other methods for increasing the rate of ultraviolet light absorption are through various types of metal oxide treatment such as alumite treatment as well as performing plating, vapor deposition and sputtering. In particular, ultraviolet light absorption of 99.9% or more at the surface is possible if-various types of metals such as silver or aluminum or the like are subjected to half-finish coating or processing with No. Bn-10 in the Japan Coating Industry Color Sample Book.

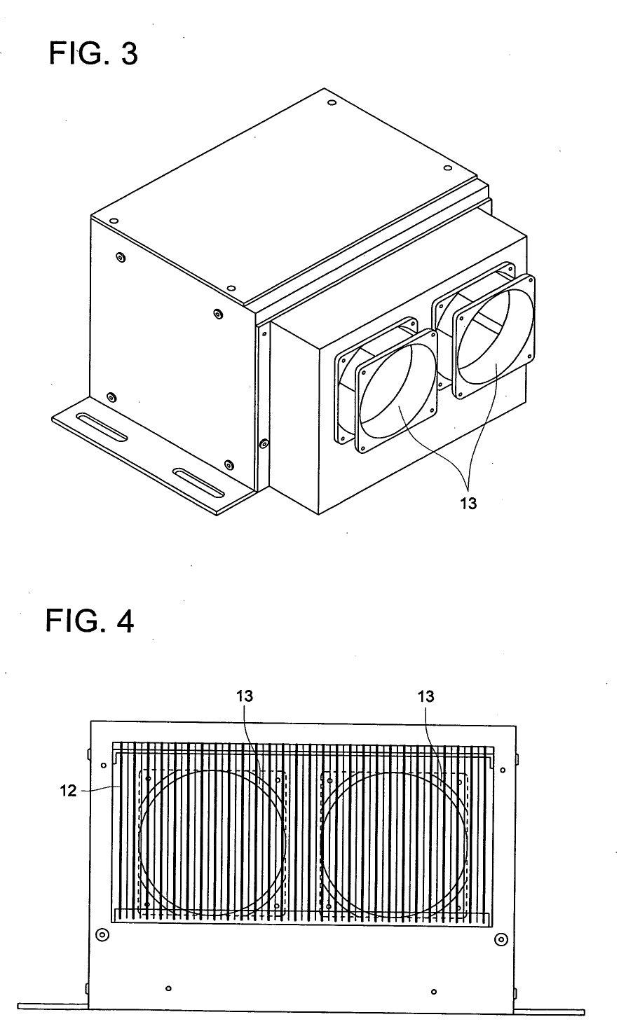

It is preferable that the surface of the object for irradiation 11 is a flat surface and that the space between this surface and the lower end of the irradiation device 5 is less than 5 mm. The surface for irradiation may be parallel to the irradiation device 5 as shown in FIG. 2, or alternatively the surface for irradiation may be inclined such that of the space between surface for irradiation and the irradiation device 5 that is closer to the recording head 4 is small and that which is further away is large.

As shown in FIG. 2, a plurality of fins 12 are provided so as to be erect on the back surface side of the object for irradiation 11. The fins 12 are cooling means for the object for irradiation 11 and assist in discharging heat from the object for irradiation 11 which is heated by the ultraviolet light irradiated from the heat source 6 of the irradiation device 5 or heat generated from the light source 6.

Furthermore as shown in FIG. 3 and FIG. 4, the cooling means for the object for irradiation 11 may be one in which cooling fans 13 for cooling the fins 12 which are erected on the back surface side of the object for irradiation 11 are provided from the direction perpendicular to the longitudinal direction of the fins 12 such that air can be circulated.

It is to be noted that the cooling means for the object for irradiation 11 may also be a device which performs water-cooling of the object for irradiation 11.

Next the control section 14 in this embodiment will be described with reference to FIG. 5. The control section 14 is constituted by a CPU, ROM and RAM (none of which are shown), and the processing programs recorded on the ROM are opened on the RAM and are executed by the CPU.

The memory section 15, the image processing section 16, the head drive section 17 which drives the recording head 4, the recording head 4, the primary scanning mechanism 18, the conveying mechanism 19, the light source 6 and the cooling fans 13 are electrically connected to the control section 14, and the control section 14 controls the driving of each of the foregoing structural parts.

The host system 20 is connected to the inkjet recording apparatus 1 by way of the network. In addition to sending the image data for recording to the inkjet recording apparatus 1, input for controlling all the operations of the inkjet recording apparatus 1 can be done at the host system 20.

The memory section 15 includes a data buffer, and can temporarily store the coded image data which is input at the host system 20 and sent via the interface (I/F) 21. Because the communication speed between the host system 20 and the image processing section 16 of the inkjet recording apparatus 1 is considerably faster than the speed at which the image data received by the image processing section 16 is recorded on the recording medium P, the memory section 15 temporarily stores the image data received from the host system 20, and the image processing section 16 sequentially reads the image data in accordance with the printing speed and performs the recording. In the memory section 15 of this embodiment, image data for at least two scanning operations can be stored in the memory section 15 and when the carriage is in the memory area and performing recording, even if image data for a maximum of one scanning operation remains in the memory section 15, new image data for one scanning operation can be received and stored.

The image processing section 16 decodes the coded input image data that is stored in the memory section 15 to a data format that can be processed by the inkjet recording apparatus 1 and sends the data to the head drive section 17.

The head drive section 17 drives the recording head 4 such that data relating to recorded image obtained at the image processing section 16 is recorded based on the signals sent from the control section 14.

The primary scanning mechanism 18 includes a drive motor (not shown) for driving the carriage 3, and the control section 14 causes the carriage 3 to scan in the primary scanning direction along the guide rail 7 by controlling the drive motor to drive.

The conveying mechanism 19 includes the platen 2, the recording medium winding roller 9, and the conveying motor and the conveying roller 8. The control section 14 periodically drives the conveying motor and conveying roller 8 to rotate by controlling the driving of the conveying motor. At the time of image recording, the recording medium P which is wound on the recording medium winding roller 9 is conveyed out in a prescribed feed amount and thus the recording medium P is intermittently conveyed.

The irradiation device 5 irradiates the ink that landed on the recording medium P with ultraviolet light from the light source 6 when the control section 14 turns on the light source 6 and the ink is thereby cured.

The control section 14 controls the drive motor of the primary scanning mechanism 18 such that the carriage 3 is driven back and forth in the primary scanning direction. During image recording, the conveying roller 8 of the conveying mechanism 19 is driven and controlled such that the recording medium P is conveyed in the secondary scanning direction, and the driving of head drive section 17 is driven and controlled such that ink of a prescribed color can be jetted from the jetting port of the recording head 4 based on prescribed image recording information which is input from the host system 20 and stored in the memory section 15 via the interface 21. In addition, the light source 6 is controlled so as to irradiate light onto the ink that landed on the recording medium P.

The control section 14 also determines whether image data recording is completed. If the recording process is completed, the carriage 3 is moved to the standby position, while if the recording process is not completed, a determination is made as to whether the image data remaining in the memory section 15 is for one scanning operation or more. As a result, in the case where the image data remaining in the memory section 15 is for one scanning operation or more, the carriage 3 remains in the recording area and image recording on the recording medium P is performed. In the case where the image data is less than the amount for one scanning operation, the carriage 3 moves above the cooling unit 10 which is the standby position and the image data continues to be stored in the memory section 15.

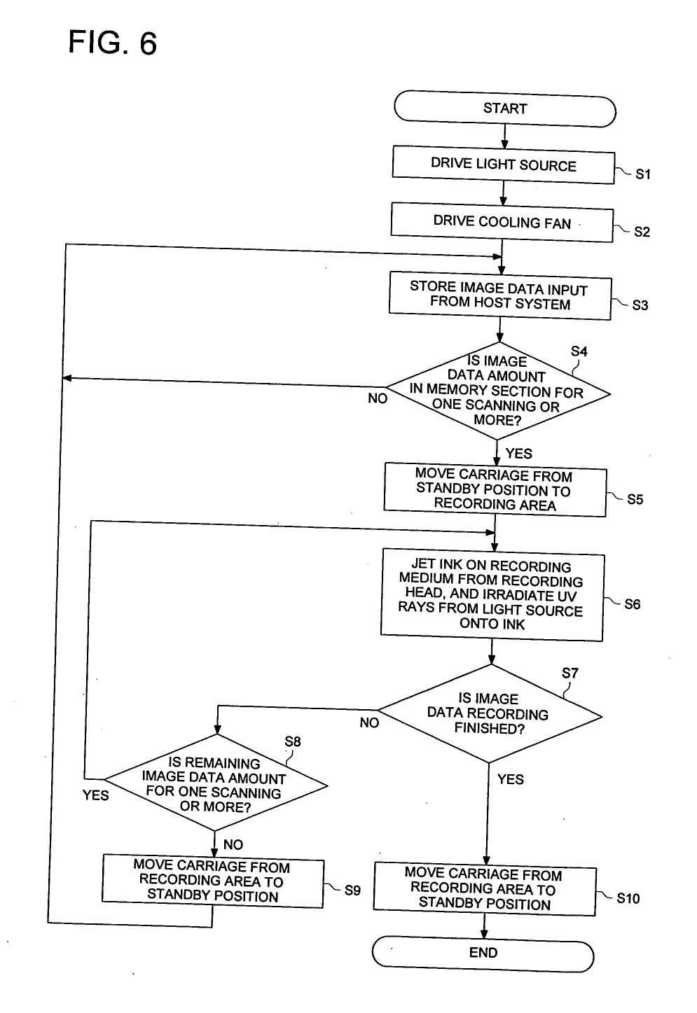

Next, the effects of this embodiment will be described with reference to FIG. 6.

When the power source for the inkjet recording apparatus 1 of this embodiment is turned on, the control section 14 drives the light source 6 (Step S1) and the cooling fan 13 is then driven to rotate (Step S2). The carriage 3 is on standby above the cooling unit 10a which is a standby position when recording is not being performed.

When a prescribed image data is input into the host system 20 and sent to the inkjet recording apparatus 1 via the interface 21, the prescribed image data is stored in the memory section 15 (Step S3). If the control section 14 determines that image data for at least one scanning operation or more of the carriage 3 is stored in the memory section 15 at the time of recording, recording on the recording medium is started (Step S4). On the other hand, the control section 14 does not start the recording process until it determines that image data for one scanning operation is stored in the memory section 15. In this case, image data continues to be stored in the memory section 15 in the state where the carriage 3 is on standby above the cooling unit 10a which is a standby position (Step S3).

When the recording process starts, the control section 14 moves the carriage 3 from above the cooling unit 10a which is the standby position to the recording area by driving the drive motor (Step S5). The carriage 3 then performs scanning in the recording area and ink is jetted from the nozzles of the recording head 4 based on prescribed image data while the recording medium P is conveyed in the secondary scanning direction on the platen 2 by the roller 8 being controlled and driven. The light source 6 of the irradiation device 5 which is provided at both sides of the carriage 3 irradiates ultraviolet light and cures the ink which ink lands on the recording medium P (Step S6).

Next, the control section 14 determines whether the image data recording is completed (Step S7).

If the results indicate the image data recording is completed, the carriage 3 moves to the standby position (Step S10) and the recording process ends.

On the one hand, if the image data recording is not completed, the control section 14 determines whether the image data remaining in the memory section 15 is image data for one scanning operation or more (Step S8). In the case where the image data is for one scanning operation or more, the carriage 3 remains in the recording area and the recording process is performed on the recording medium P (Step S6). Meanwhile, if the image data remaining in the memory section 15 is less than the amount for one scanning operation, the carriage 3 moves to the standby position (Step S9), and when the carriage 3 is on standby at the standby position, the memory section 15 once again stores a prescribed image data that is sent from the host system 20 (Step S3). If it is determined that image data for one scanning operation is stored in the memory section 15, recording on the recording medium P is restarted (Step S4).

When the recording process is completed, the control section 14 moves the carriage above the cooling units 10a or 10b representing the standby positions that is closer to the carriage at that point (Step S10). For example, if the carriage is on standby above the cooling unit 10a which is a standby-position at first, and image data for three scanning operations is stored in the memory section 15 and recording begins, when recording is completed, the carriage is moved above the cooling unit 10b which is the standby position at the opposite side which is interposed between the area above the cooling unit 10a which is the original standby position and the platen 2. Also, in the case where printing was started in the case where image data for four scanning is stored, after the recording process is completed, the carriage 3 is moved above the cooling unit 10a which is the same as the original standby position.

When the carriage 3 is above the cooling unit 10a or 10b which are the standby positions, the irradiation device 5 continues to drive the light source 6 in standby mode, but the object for irradiation 11 receives radiation of the light from the light source 6 of the irradiation device 5. The heat that is generated here is released by the fin 12. Meanwhile, the fin 12 is cooled by the cooling operation of the cooling fan 13. As a result, it is not necessary to turn off the irradiation device 5 when the carriage 3 is on standby, and in addition, the heat that is generated by the heat from the light irradiated on the object for irradiation 11 is effectively released.

In addition, reflection of light from the surface of the object for irradiation 11 is suppressed as much as possible, and even if light is reflected, it does not enter the recording head side, and thus light does not enter the nozzles of the recording head 4. Accordingly, even if when the carriage 3 is on standby and light from the irradiation device 5 is reflected at the surface of the object for irradiation 11, adverse effects on the recording head 4 caused by this reflected light is reduced.

As described above, according to this embodiment, the standby position of the carriage 3 is positioned at both ends of the scanning range of the carriage 3 and because the control section 14 waits until when image data for one scanning operation is stored in the memory section 15 before the carriage 3 scans the recording range, the carriage 3 never stops at a location other than the standby position after the start of recording because data transfer from the host system 20 or data processing is delayed. As a result, the situation is avoided where ultraviolet light continues to be irradiated onto the recording medium P or the platen 2 from the light source in a state in which the carriage 3 is at a location other than the standby position. Furthermore, the carriage 3 is stopped above the cooling unit 10a or 10b which are standby positions when recording is not being performed, and thus the situation where the ultraviolet light which leaks from the light source 6 is irradiated inside the inkjet recording apparatus 1 is avoided.

In addition, because the light source of the irradiation device 5 irradiates light on the object for irradiation 11 of the cooling units 10a and 10b at the carriage 3 standby position, and the light that is irradiated on the surface for irradiation of the object for irradiation 11 is absorbed by an absorbent material, even if the light source 6 remains on when at the standby position, it becomes possible for the effect of heat on the object for irradiation 11 to be reduced. In addition, there is no possibility of light reflecting from the surface of the object for irradiation and adverse effects caused by reflected light, such as reflected light entering the recording head, are suppressed.

Furthermore, because the object for irradiation 11 is actively cooled by the fin 12 and the cooling fan 13, the effect of heat generated from the light which a light source 6 irradiates is effectively reduced.

In addition, because the light source 6 radiates ultraviolet light in order to cure the ink, curing properties are higher than when using light sources that irradiate other lights and cost is kept low.

Because cation polymerizable ink which is an ink with high curing sensitivity is cured by light source 6 which has comparatively low output, it becomes possible to use a low output light source.

### Second Embodiment

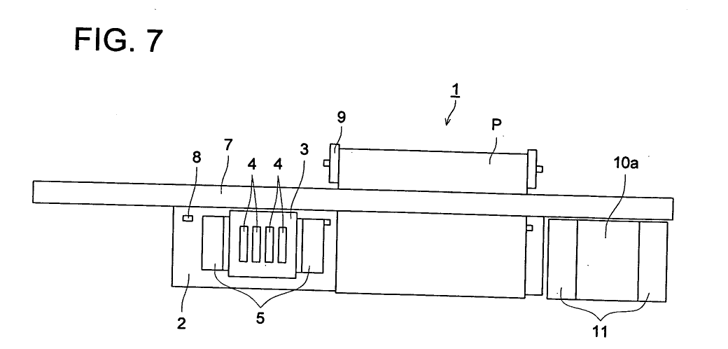

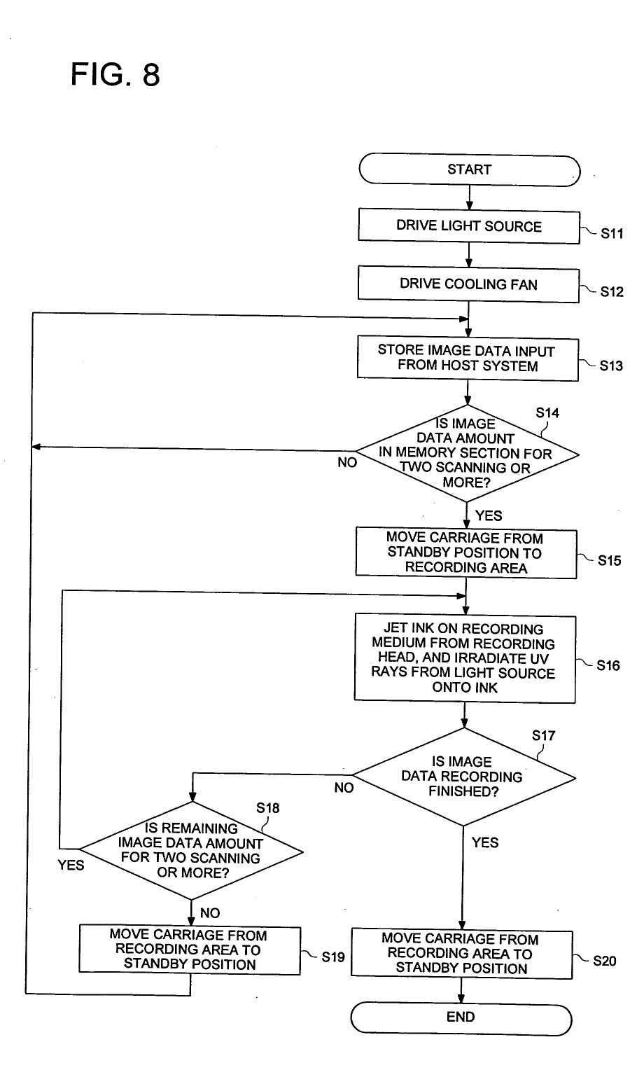

Next, the second embodiment of this invention will be described using FIG. 7 and FIG. 8. It is to be noted that the parts which are the same as those of the first embodiment are assigned the same numbers and descriptions thereof have been omitted and only parts different from the first embodiment are described.

In the inkjet recording apparatus 1 of this invention, as shown in FIG. 7, a flat cooling unit 10a is disposed at one end of the scanning range of the carriage 3, and the area above the cooling unit 10a is the carriage 3 standby position.

The memory section 15 stores image data for at least three scanning operations, and when the carriage 3 is in the recording area and performing recording, even when image data for a maximum of two scanning operations remains in the memory section 15, new image data for one scanning operation can be received and stored.

The control section 14 also determines whether recording of image data is completed. In addition, if the recording process is completed, the carriage 3 is moved to the standby position and if the recording process is not completed, a determination is made as to whether the image data remaining in the memory section 15 is the amount for two scanning operations or more. If the results indicate that the image data remaining in the memory section 15 is for two scanning operations or more, the carriage 3 remains in the recording area and recording on the recording medium P is performed. In the case where the image data is less than that for two scanning operations, the carriage 3 moves above the cooling unit 10a which is the standby position and the image data continues to be stored in the memory section 15.

The following is a description of this embodiment with reference to FIG. 8.

Steps S11 through S13 are the same as Steps S1 through S3 in the first embodiment.

When the control section 14 determines that image data for at least two scanning operations of the carriage 3 is stored in the memory section 15 during recording, the recording on the recording medium P is started (Step S14). On the other hand, the control section does not start the recording process until it determines that image data for two scanning operations is stored in the memory section 15. In this case, image data continues to be stored in the memory section 15 in the state where the carriage 3 is on standby above the cooling unit 10a which is a standby position (Step S13).

Steps S15 through S17 are the same as Steps S5 through S7 in the first embodiment.

In addition, if a determination is made in Step S17 that the recording process is not completed, the control section 14 determines whether image data for two scanning operations or more remain in the memory section 15 (Step S18). In the case where the image data for two scanning operations or more remain, the carriage 3 remains in the recording area and the recording is performed on the recording medium P (Step S16). Meanwhile, if the image data remaining in the memory section 15 is less than the amount for two scanning operations, the carriage 3 moves to the standby position (Step S19), and when on standby at the standby position, the memory section 15 once again stores prescribed image data that is sent from the host system 20 (Step S13).

In this manner, when the recording process is completed, the control section 14 moves the carriage above the cooling unit 10a which is a standby position (Step S20).

As described above, according to this embodiment, even if the carriage 3 standby position is positioned at only one end of the scanning range of the carriage 3, because the control section 14 waits until image data received from the external device for two scanning operations is stored in the memory section 15 before the carriage is allowed to scan in the recording area, and image recording can be performed without the carriage 3 stopping at a location other than the standby position. As a result, the same effects as the first embodiment are obtained.

In addition, when the structure in which the carriage 3 standby position is only at one end of the scanning range of carriage 3, if the memory section 15 receives new image data while the carriage 3 is in the recording area, capacity for image data being recorded for a maximum of two scanning operations is ensured in the memory section, and also capacity for one scanning operation is ensured for the new image data, and thus the same effects as the first embodiment can be obtained.

According to the inkjet recording apparatus 1 of the invention described above, even in the case where after the recording starts, data transfer or data processing from the host system 20 is delayed, because the carriage 3 does not stop at a location other than the standby position, heating of the recording medium and the platen which supports the recording medium to high temperatures due to heat from the light source can be suppressed. As a result, deformation of the recording medium and the platen is prevented, and flatness of the recording medium during recording is ensured and reduction in image quality is avoided.

In addition, because the object for irradiation absorbs heat from the light source at the standby position, the temperature of the carriage itself is prevented from increasing due to the radiant heat from the light source, and thus loss of the drive stability of the recording head and the light source, as well as reduction in lifespan of the apparatus can be avoided. In addition, because the carriage is stopped at the standby position when recording is not being performed, ultraviolet light which leaks from the light source is prevented from being irradiated inside the recording apparatus and causing deterioration of the mechanisms or causing the ink to cure at portions where this is not needed.

Furthermore, by actively cooling the object for irradiation, heating of the internal parts of the inkjet recording apparatus to high temperatures is prevented, and thus impairment of drive stability of the recording head and the light source which are loaded on the carriage, as well as reduction in lifespan of the apparatus itself can be avoided.

What is claimed is:

1. An inkjet recording apparatus comprising:
(a) a recording head of a serial method provided with a nozzle for jetting photocurable ink to a recording medium:
(b) a light source for hardening the photocurable ink by irradiating light onto the photocuable ink deposited on the recording medium;
(c) a main scanning mechanism for reciprocating a carriage on which the recording head and the light source are provided, in a main scanning direction;
(d) at least one irradiated body provided at a standby position of the carriage which is located in at least one end of a scanning range of the carriage for absorbing heat projected from the light source;
(e) a memory section for temporarily storing image data received from an external device, having a capacity of storing the image data required for at least one scanning operation; and
(f) a controller for controlling the carriage to wait at the standby position and not to scan until the image data for one scanning operation or more is stored in the memory section.

2. The inkjet recording apparatus of claim 1,
wherein at least the one irradiated body comprises two irradiated bodies each which is provided at the standby position in both ends of the scanning range, and
wherein the controller controls the carriage to wait at the standby position and not to scan until the image data for one scanning operation is stored in the memory section.

3. The inkjet recording apparatus of claim 1,
wherein at least the one irradiated body comprises one irradiated body which is provided at the standby position in one end of the scanning range,
wherein the memory section has the capacity of storing the image data required for at least two scanning operation, and
wherein the controller controls the carriage to wait at the standby position and not to scan until the image data for two scanning operations is stored in the memory section.

4. The inkjet recording apparatus of claim 3, wherein the memory section has a capacity of storing the image data required for at least three scanning operations or more.

5. The inkjet recording apparatus of claim 1, further comprising a cooling device for cooling the irradiated body.

6. The inkjet recording apparatus of claim 2, further comprising a cooling device for cooling the irradiated body.

7. The inkjet recording apparatus of claim 3, further comprising a cooling device for cooling the irradiated body.

8. The inkjet recording apparatus of claim 4, further comprising a cooling device for cooling the irradiated body.

9. The inkjet recording apparatus of claim 1, wherein the light source irradiates UV rays.

10. The inkjet recording apparatus of claim 2, wherein the light source irradiates UV rays.

11. The inkjet recording apparatus of claim 3, wherein the light source irradiates UV rays.

12. The inkjet recording apparatus of claim 4, wherein the light source irradiates UV rays.

13. The inkjet recording apparatus of claim 7, wherein the light source irradiates UV rays.

14. The inkjet recording apparatus of claim 1, wherein the photocuable ink is cation polymerizing ink.

15. The inkjet recording apparatus of claim 2, wherein the photocuable ink is cation polymerizing ink.

16. The inkjet recording apparatus of claim 3, wherein the photocuable ink is cation polymerizing ink.

17. The inkjet recording apparatus of claim 4, wherein the photocuable ink is cation polymerizing ink.

18. The inkjet recording apparatus of claim 7, wherein the photocuable ink is cation polymerizing ink.

19. The inkjet recording apparatus of claim 11, wherein the photocuable ink is cation polymerizing ink.
